(19) United States
(12) Patent Application Publication
(10) Pub. No.: US 2026/0034562 A1
(43) Pub. Date: Feb. 5, 2026

(54) LIQUID APPLICATOR ASSEMBLY WITH DUAL ROLLERS

(71) Applicants: Ted Joseph Dziurda, Shuniah (CA); Andrew Nicholas William Maltese, Shuniah (CA); Chad Edward Dziurda, Shuniah (CA); Deanna Lee Maltese, Shuniah (CA)

(72) Inventor: Ted Joseph Dziurda, Shuniah (CA)

(21) Appl. No.: 18/788,424

(22) Filed: Jul. 30, 2024

(51) Int. Cl. B05C 17/02

(52) U.S. Cl. CPC B05C 17/023; B05C 17/022

(57) ABSTRACT

An applicator roller assembly supports two roller sleeves for applying a liquid to a surface, such as painting a wall. The assembly has a rigid frame supporting first and second shaft members rotatably on the frame so that the shaft members mount the rollers sleeves thereon for rotation about first and second roller axes that are parallel to one another in a common roller plane. A handle body, that is arranged to be gripped in a hand of a user, extends along a handle axis in fixed orientation relative to the rigid frame such that the handle body extends transversely to the common plane of the first and second roller axes. The rigid connection between the handle body and the location of the roller axes on the rigid frame enables the user to controllably vary the amount of pressure applied to the surface by either one of the roller sleeves.

### FIELD OF THE INVENTION

The present invention relates to a roller assembly arranged to support a pair of applicator roller sleeves rotatably thereon for applying a liquid, for example paint and the like, to a suitable substrate surface such as a floor or a wall.

### BACKGROUND

When applying liquid to large surface areas, for example applying paint to a wall, it is common to use a roller assembly having a frame with a handle for being gripped in the hand of a user and a shaft member supporting a disposable roller sleeve rotatably thereon for applying the liquid to the surface.

U.S. Pat. No. 3,130,435 by Smith discloses a painting device having a frame supporting two parallel shaft members rotatably thereon for supporting two roller sleeves rotatably on the frame to increase the amount of liquid able to be carried by the roller assembly for application to the surface. In order to apply even pressure onto the surface from the two rollers, the handle is coupled to the frame for pivotal movement about a pivot axis lying parallel to the roller axes so that the frame supporting the rollers thereon can be balanced about the pivot axis of the handle regardless of the inclination of the handle relative to the surface. As the frame is specifically intended to apply even pressure with both rollers, both rollers must be actively engaged with the surface at all times.

### SUMMARY OF THE INVENTION

According to one aspect of the invention there is provided an applicator roller assembly for use with first and second roller sleeves, the assembly comprising:
a rigid frame;
a first shaft member rotatably supported on the rigid frame and arranged to support the first roller sleeve thereon for rotation with the first shaft member relative to the rigid frame about a first roller axis;
a second shaft member rotatably supported on the rigid frame and arranged to support the second roller sleeve thereon for rotation with the second shaft member relative to the rigid frame about a second roller axis, in which the second roller axis is parallel to the first roller axis and spaced from the first roller axis within a common plane of the first and second roller axes; and
a handle body arranged to be gripped in a hand of a user, the handle body being elongated along a handle axis, in which the handle body is mounted in fixed orientation relative to the rigid frame such that the handle axis extends transversely to the common plane of the first and second roller axes.

By supporting the handle body at a fixed orientation relative to the rigid frame, the user can controllably vary the amount of pressure applied by either roller. In this instance, the user can choose to use both rollers at some times, or controllably use only one of the rollers at other times for smaller surface areas when desired. Alternatively, one roller can be used for applying liquid using greater pressure, while the other roller smooths out any uneven application of liquid by the first roller using less pressure by burying the pressure applied by transferring forces from the hand of the user to the rollers through the rigid frame.

Preferably the handle axis lies in a handle plane oriented perpendicularly to the common plane of the first and second roller axes.

The handle axis may lie at a fixed inclination of between 25 and 70 degrees from the common plane of the first and second roller axes.

When directly gripping the handle body directly in a hand of the user for applying a liquid to an upright supporting surface, the handle axis preferably lies at an inclination within a range of 25 to 40 degrees from the common plane of the first and second roller axes.

Alternatively, when the handle body includes a threaded socket formed therein so as to be arranged for attachment to an extension pole to apply liquid to a floor surface for example, the handle axis preferably lies at an inclination of between 40 and 75 degrees from the common plane of the first and second roller axes.

Preferably the first and second roller axes are spaced apart from one another by a distance within a range of 3 to 4 inches. In this instance, when roller sleeves are mounted onto the first and second shaft members of the assembly, the first and second roller sleeves are spaced apart from one another by a distance equal to or less than one inch.

Preferably the handle axis intersects the common plane of the first and second roller axes adjacent to the second roller axis. In the illustrated embodiment, the handle axis intersects the common plane of the first and second roller axes at a location spaced from the second roller axis in a direction opposite to the first roller axis.

The rigid frame of the applicator roller assembly may comprises: (a) a crossbar spanning between the first and second roller axes within the common plane and supporting the first and second shaft members rotatably thereon, and (b) a transverse frame member extending linearly between a first end connected to the crossbar within the common plane and a second end supporting the handle body thereon, in which the second end of the transverse frame member is (i) spaced from the common plane of the first and second roller axes and (ii) centrally located in an axial direction of the first and second shaft members.

### BRIEF DESCRIPTION OF THE DRAWINGS

One embodiment of the invention will now be described in conjunction with the accompanying drawings in which:

FIG. 1 is a perspective view of the applicator roller assembly according to the present invention shown with a roller sleeve arranged to be mounted on either one of the shaft members of the assembly.

FIG. 2 is a side elevational view of the applicator roller assembly according to FIG. 1;

FIG. 3 is a rear elevational view of the applicator roller assembly according to FIG. 1; and

FIG. 4 is a top plan view of the applicator roller assembly according to FIG. 1.

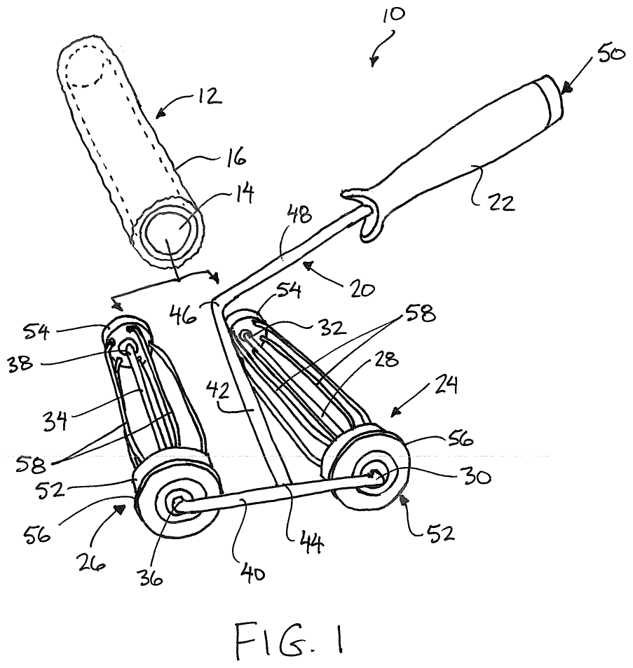

In the drawings like characters of reference indicate corresponding parts in the different figures.

### DETAILED DESCRIPTION

Referring to the accompanying figures there is illustrated an applicator roller assembly generally indicated by reference numeral 10. The assembly 10 is particularly suited for use with conventional paint roller sleeves 12 for applying a liquid to a surface, for example painting a wall or applying a coating to a floor.

A typical roller sleeve 12 includes a rigid inner tube 14 which is externally covered by a suitable applicator material 16 such as a sponge or a mat of applicator hairs of equal length protruding radially from the inner tube. A typical roller sleeve is approximately 2.5 inches in diameter and 9 inches long.

The assembly 10 according to the present invention generally comprises (i) a rigid frame 20 that includes a handle body 22 that is fixed in orientation relative to the frame 20 and that is suitably sized and configured for being gripped in a single hand of the user, and (ii) first and second shaft members 24 and 26 which support first and second roller sleeves 12 respectively thereon such that the roller sleeves are rotatable about respective first and second roller axes relative to the rigid frame.

The rigid frame 20 includes a first rigid shaft 28 that defines the first roller axis of the first shaft member 24 supported concentrically thereon. The first rigid shaft 28 spans the length of the first shaft member and roller sleeve supported thereon. The first rigid shaft 28 extends in a first axial direction from a proximal end 30 to a distal end 32 of the shaft.

The rigid frame 20 also includes a second rigid shaft 34 that similarly defines the second roller axis of the second shaft member 26 supported concentrically thereon. The second rigid shaft spans the length of the second shaft member and roller sleeve supported thereon. The second rigid shaft 34 extends in a second axial direction from a proximal end 36 to a distal end 38 of the shaft.

A crossbar 40 is connected between the proximal end 30 of the first rigid shaft 28 and the proximal end 36 of the second rigid shaft so that the first rigid shaft, the second rigid shaft and the crossbar are all fixed immovably in orientation relative to one another while lying in a common roller plane P with one another. The crossbar extends perpendicularly between the first and second rigid shafts and supports the rigid shafts such that the first and second axial directions of the rigid shafts are parallel to one another and spaced apart from one another by a distance Y that is between 3 and 4 inches.

A transverse frame member 42 is connected between the crossbar 40 and the handle body 22. More particularly, the transverse frame member 42 extends linearly between a first end 44 and a second end 46 of the transverse frame member. The first end 44 is mounted at a central location on the crossbar 40 between the first and second rigid shafts 28 and 34. The second end 46 of the transverse frame member is spaced from the common roller plane P in a direction of the handle body 22, while being centred in the longitudinal direction of the crossbar 40 between the first and second shaft members, while being further centred in the axial direction of the first and second shaft members between the proximal and distal ends thereof.

The rigid frame 20 further includes a handle member 48 which is rigidly connected to the second end 46 of the transverse frame member to extend away from the common roller plane in the direction of the handle body 22. The handle body is elongated in a longitudinal direction of the handle member 48 about which the handle body is formed at an outer end portion of the handle member furthest from the common roller plane. The handle body 22 includes an internally threaded socket 50 formed in the distal end of the handle body furthest from the remainder of the rigid frame and the shaft members supporting the roller sleeves thereon. The socket 50 includes a central axis that is coaxial with the handle axis for forming a threaded connection to a threaded male connector at the end of an extension pole so that the handle axis is coaxial with the extension pole when the extension pole is mounted onto the assembly 10. A longitudinal axis of the handle member 48 and the handle body supported thereon lies in a handle plane that is perpendicular to the roller axes. Furthermore, the handle axis extends at a slope upwardly and away from the common roller plane at a fixed and immovable angle X.

When it is desired to grip the handle body directly in the hand of a user for applying liquid to an upright supporting surface for example, the handle axis is preferably oriented at a slope or angle X of between 25 and 40 degrees to the common roller plane P as shown in the illustrated embodiment.

Alternatively, when it is desired to use the assembly with an extension pole mounted in the socket 50, the handle axis may be oriented at a slope or angle X of between 40 and 70 degrees to the common roller plane P.

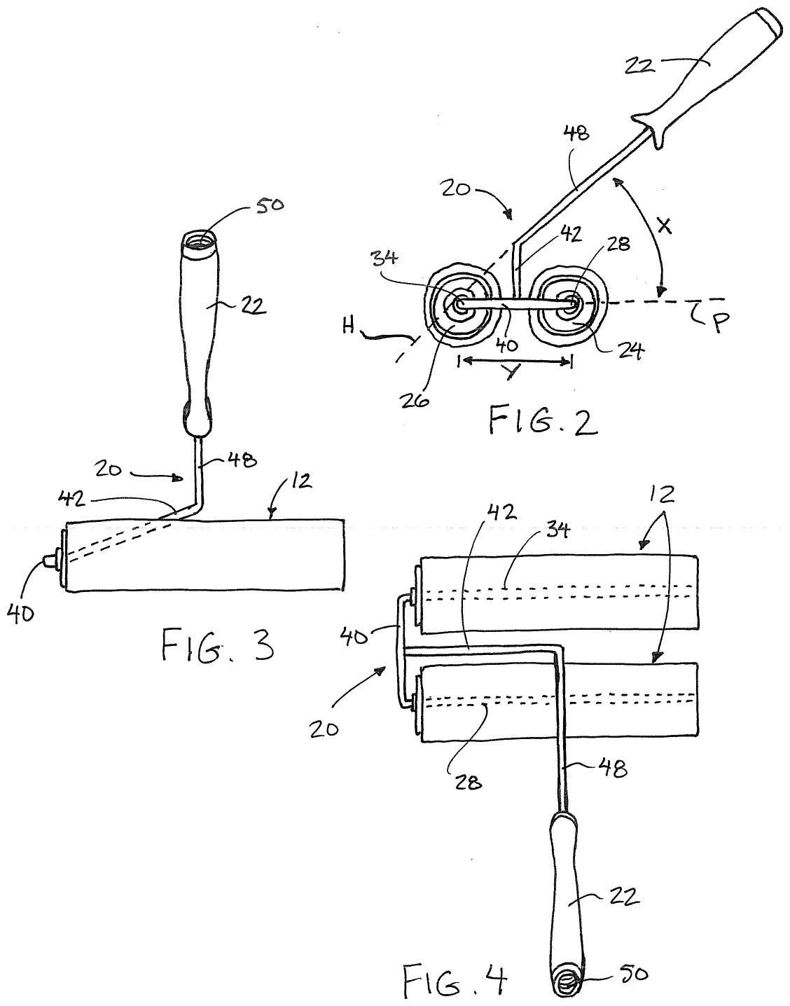

When the handle axis lies at an angle of approximately 40 degrees or less relative to the common roller plane P according to FIG. 2, the handle axis H intersects the common roller plane at a location in proximity to the second rigid shaft 28 corresponding to the second roller axis while being spaced outwardly from the second roller axis in a direction away from the first roller axis. Alternatively, when the handle axis lies at a steeper angle of greater than 40 degrees to the common roller plane P, the handle axis H may intersect the common roller plane P at an intermediate location between the first and second shafts 28 and 34.

The handle body 22 is an enlarged body surrounding an end portion of the handle member 48. As stated above, the handle body is elongated in a direction of the handle axis so as to be suitably sized and configured for gripping in one hand of the user while following the slope of the handle member relative to the common roller plane.

The first and second shaft members 24 and 26 that are rotatably supported on the first shaft 28 and second shaft 34 of the frame respectively are similar to the roller cages of conventional roller applicators for supporting individual roller sleeves thereon. More particularly, each shaft member 24 and 26 includes a first end portion 52 and a second end portion 54 at axially opposed ends having cylindrical outer surfaces that closely matched the inner diameter of the roller sleeves for supporting opposing ends of a roller sleeve thereon. Each end portion further includes a central aperture therein which is rotatably supported on a respective one of the rigid shafts 28 or 34. An end flange 56 is provided at the outermost end of the first end portion 52 nearest to the crossbar in which the end flange protrudes radially relative to the cylindrical outer surface of the end portion so as to receive one end of the roller sleeve 12 abutted against the end flange 56 in a mounted position of the roller sleeve on the shaft member. The first and second end portions 52 and 54 are connected by an intermediate frame portion 58 comprised of a plurality of resilient bars extending axially between the first and second end portions at circumferentially spaced positions relative to one another. The bars of the frame portion 58 are resilient and define an outer diameter in a relaxed state which is slightly greater than an inner diameter of the roller sleeve to be mounted thereon. Sliding the roller sleeve onto the shaft member causes the bars of the frame portion to be flexed radially inwardly while frictionally retaining the roller sleeve thereon in a mounted position.

In use, an operator mounts roller sleeves 12 onto the first and second shaft members 24 and 26 of the assembly 10 such that the roller sleeves are rotatable with the respective shaft members relative to the first rigid shaft 28 and second rigid shaft 34 of the rigid frame. The location of the corresponding first and second roller axes relative to the handle body gripped in the hand of the user remains fixed and immovable in orientation. The operator dips the rollers into a tray of liquid to be applied for loading the rollers with liquid. The roller assembly is then transferred to the surface onto which the liquid is to be applied.

For large areas, the user typically keeps both roller sleeves engaged with the surface as the rollers are rolled along the surface to spread the liquid onto the surface using movement of the wrist of the user to keep the angle of the handle body relative to the surface at a fixed slope and thereby control even pressure onto the surface from both rollers.

At any time, the user can optionally change the angle of the handle body relative to the surface to apply more pressure with a selected one of the rollers, or yet further to disengage one of the rollers from the surface entirely if it is desired to use only a single roller for smaller surface areas to be coated for example. Similarly, by controlling the angle of the handle body relative to a paint tray, the user can controllably dip only a single roller into the tray if desired. In this manner, the user has a high degree of control to vary whether one or both rollers are actively being used to load liquid onto the rollers and/or apply liquid from the rollers onto the surface.

Since various modifications can be made in the invention as herein above described, and many apparently widely different embodiments of same made, it is intended that all matter contained in the accompanying specification shall be interpreted as illustrative only and not in a limiting sense.

1. An applicator roller assembly for use with first and second roller sleeves, the assembly comprising:
a rigid frame;
a first shaft member rotatably supported on the rigid frame and arranged to support the first roller sleeve thereon for rotation with the first shaft member relative to the rigid frame about a first roller axis;
a second shaft member rotatably supported on the rigid frame and arranged to support the second roller sleeve thereon for rotation with the second shaft member relative to the rigid frame about a second roller axis, in which the second roller axis is parallel to the first roller axis and spaced from the first roller axis within a common plane of the first and second roller axes; and
a handle body arranged to be gripped in a hand of a user, the handle body being elongated along a handle axis, in which the handle body is mounted in fixed orientation relative to the rigid frame such that the handle axis extends transversely to the common plane of the first and second roller axes.

2. The assembly according to claim 1 wherein the handle axis lies in a handle plane oriented perpendicularly to the common plane of the first and second roller axes.

3. The assembly according to claim 1 wherein the handle axis lies at a fixed inclination of between 25 and 70 degrees from the common plane of the first and second roller axes.

4. The assembly according to claim 1 wherein the handle axis lies at a fixed inclination within a range of 25 to 40 degrees from the common plane of the first and second roller axes.

5. The assembly according to claim 1 wherein the handle body includes a threaded socket formed therein so as to be arranged for attachment to an extension pole, and wherein the handle axis lies at a fixed inclination of between 40 and 75 degrees from the common plane of the first and second roller axes.

6. The assembly according to claim 1 wherein the first and second roller axes are spaced apart from one another by a distance within a range of 3 to 4 inches.

7. The assembly according to claim 1 wherein the handle axis intersects the common plane of the first and second roller axes adjacent to the second roller axis.

8. The assembly according to claim 1 wherein the handle axis intersects the common plane of the first and second roller axes at a location spaced from the second roller axis in a direction opposite to the first roller axis.

9. The assembly according to claim 1 wherein the rigid frame comprises:
a crossbar spanning between the first and second roller axes within the common plane and supporting the first and second shaft members rotatably thereon; and
a transverse frame member extending linearly between a first end connected to the crossbar within the common plane and a second end supporting the handle body thereon;
wherein the second end of the transverse frame member is (i) spaced from the common plane of the first and second roller axes and (ii) centrally located in an axial direction of the first and second shaft members.

10. The assembly according to claim 1 in combination with the first and second roller sleeves supported on the first and second shaft members respectively, the first and second roller sleeves being spaced apart from one another by a distance equal to or less than one inch.
